(19) United States
(12) Patent Application Publication
(10) Pub. No.: US 2024/0237045 A9
(43) Pub. Date: Jul. 11, 2024

(54) TRANSMITTING INTER-USER-EQUIPMENT CROSS-LINK INTERFERENCE (CLI) REFERENCE SIGNALS FOR CLI MITIGATION

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Tao LUO, San Diego, CA (US)

(21) Appl. No.: 18/466,441

(22) Filed: Sep. 13, 2023

Related U.S. Application Data
(60) Provisional application No. 63/380,427, filed on Oct. 21, 2022.

(51) Int. Cl. H04W 72/541; H04L 5/00; H04W 24/10; H04W 72/25

(52) U.S. Cl. CPC H04W 72/541; H04L 5/0037; H04W 24/10; H04W 72/25

(57) ABSTRACT

Various aspects of the present disclosure generally relate to wireless communication. In some aspects, a first user equipment (UE) may receive, from a first network node associated with the first UE, a cross-link interference (CLI) configuration. The first UE may transmit, to a second UE, an inter-UE CLI measurement reference signal based at least in part on the CLI configuration, a measurement associated with the inter-UE CLI measurement reference signal being signaled to the first network node. Numerous other aspects are described.

### CROSS-REFERENCE TO RELATED APPLICATION

This Patent application claims priority to U.S. Provisional Patent Application No. 63/380,427, filed on Oct. 21, 2022, entitled “TRANSMITTING INTER-USER-EQUIPMENT CROSS-LINK INTERFERENCE (CLI) REFERENCE SIGNALS FOR CLI MITIGATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for transmitting inter-user-equipment (UE) cross-link interference (CLI) reference signals for CLI mitigation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes one or more memories; and one or more processors, coupled to the one or more memories, which are configured, individually or in any combination, to: receive, from a first network node associated with the first UE, a CLI configuration; and transmit, to a second UE, an inter-UE CLI measurement reference signal based at least in part on the CLI configuration, the inter-UE CLI measurement reference signal being transmitted to the second UE for measurement by the second UE.

In some implementations, an apparatus for wireless communication at a second UE includes one or more memories; and one or more processors, coupled to the one or more memories, which are configured, individually or in any combination, to: receive, from a first UE, an inter-UE CLI measurement reference signal, the inter-UE CLI measurement reference signal being associated with a CLI configuration; and transmit, to a first network node associated with the first UE via a second network node associated with the second UE, a measurement associated with the inter-UE CLI measurement reference signal.

In some implementations, an apparatus for wireless communication at a first UE includes one or more memories; and one or more processors, coupled to the one or more memories, which are configured, individually or in any combination, to: receive, from a second UE, an inter-UE CLI measurement reference signal, the inter-UE CLI measurement reference signal being associated with a CLI configuration, and a channel between the first UE and the second UE being associated with a channel reciprocity; and transmit, to a first network node associated with the first UE, a measurement associated with the inter-UE CLI measurement reference signal.

In some implementations, an apparatus for wireless communication at a second UE includes one or more memories; and one or more processors, coupled to the one or more memories, which are configured, individually or in any combination, to: receive, from a second network node associated with the second UE, a CLI configuration; and transmit, to a first UE, an inter-UE CLI measurement reference signal based at least in part on the CLI configuration, the inter-UE CLI measurement reference signal being transmitted to the first UE for measurement by the first UE, and a channel between the second UE and the first UE being associated with a channel reciprocity.

In some implementations, a method of wireless communication performed by an apparatus of a first UE includes receiving, from a first network node associated with the first UE, a CLI configuration; and transmitting, to a second UE, an inter-UE CLI measurement reference signal based at least in part on the CLI configuration, a measurement associated with the inter-UE CLI measurement reference signal being signaled to the first network node.

In some implementations, a method of wireless communication performed by an apparatus of a second UE includes receiving, from a first UE, an inter-UE CLI measurement reference signal, the inter-UE CLI measurement reference signal being associated with a CLI configuration; and transmitting, to a first network node associated with the first UE via a second network node associated with the second UE, a measurement associated with the inter-UE CLI measurement reference signal.

In some implementations, a method of wireless communication performed by an apparatus of a first UE includes receiving, from a second UE, an inter-UE CLI measurement reference signal, the inter-UE CLI measurement reference signal being associated with a CLI configuration, and a channel between the first UE and the second UE being associated with a channel reciprocity; and transmitting, to a first network node associated with the first UE, a measurement associated with the inter-UE CLI measurement reference signal.

In some implementations, a method of wireless communication performed by an apparatus of a second UE includes receiving, from a second network node associated with the second UE, a CLI configuration; and transmitting, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity.

In some implementations, a non-transitory computer-readable medium storing a set of instructions for wireless communication includes one or more instructions that, when executed by one or more processors of a first UE, cause the first UE to: receive, from a first network node associated with the first UE, a CLI configuration; and transmit, to a second UE, an inter-UE CLI measurement reference signal based at least in part on the CLI configuration, a measurement associated with the inter-UE CLI measurement reference signal being signaled to the first network node.

In some implementations, a non-transitory computer-readable medium storing a set of instructions for wireless communication includes one or more instructions that, when executed by one or more processors of a second UE, cause the second UE to: receive, from a first UE, an inter-UE CLI measurement reference signal, the inter-UE CLI measurement reference signal being associated with a CLI configuration; and transmit, to a first network node associated with the first UE via a second network node associated with the second UE, a measurement associated with the inter-UE CLI measurement reference signal.

In some implementations, a non-transitory computer-readable medium storing a set of instructions for wireless communication includes one or more instructions that, when executed by one or more processors of a first UE, cause the first UE to: receive, from a second UE, an inter-UE CLI measurement reference signal, the inter-UE CLI measurement reference signal being associated with a CLI configuration, and a channel between the first UE and the second UE being associated with a channel reciprocity; and transmit, to a first network node associated with the first UE, a measurement associated with the inter-UE CLI measurement reference signal.

In some implementations, a non-transitory computer-readable medium storing a set of instructions for wireless communication includes one or more instructions that, when executed by one or more processors of a second UE, cause the second UE to: receive, from a second network node associated with the second UE, a CLI configuration; and transmit, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity.

In some implementations, a first apparatus for wireless communication includes means for receiving, from a first network node associated with the first apparatus, a CLI configuration; and means for transmitting, to a second apparatus, an inter-apparatus CLI measurement reference signal based at least in part on the CLI configuration, a measurement associated with the inter-apparatus CLI measurement reference signal being signaled to the first network node.

In some implementations, a second apparatus for wireless communication includes means for receiving, from a first apparatus, an inter-apparatus CLI measurement reference signal, the inter-apparatus CLI measurement reference signal being associated with a CLI configuration; and means for transmitting, to a first network node associated with the first apparatus via a second network node associated with the second apparatus, a measurement associated with the inter-apparatus CLI measurement reference signal.

In some implementations, a first apparatus for wireless communication includes means for receiving, from a second apparatus, an inter-apparatus CLI measurement reference signal, the inter-apparatus CLI measurement reference signal being associated with a CLI configuration, and a channel between the first apparatus and the second apparatus being associated with a channel reciprocity; and means for transmitting, to a first network node associated with the first apparatus, a measurement associated with the inter-apparatus CLI measurement reference signal.

In some implementations, a second apparatus for wireless communication includes means for receiving, from a second network node associated with the second apparatus, a CLI configuration; and means for transmitting, to a first apparatus, an inter-apparatus CLI measurement reference signal based at least in part on the CLI configuration, a measurement associated with the inter-apparatus CLI measurement reference signal being signaled to a first network node associated with the first apparatus, and a channel between the second apparatus and the first apparatus being associated with a channel reciprocity.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex (FD) communications, in accordance with the present disclosure.

FIG. 5 is a diagram illustrating examples of FD communications, in accordance with the present disclosure.

FIGS. 6-8 are diagrams illustrating examples of cross-link interference (CLI), in accordance with the present disclosure.

FIGS. 9-10 are diagrams illustrating examples associated with transmitting inter-UE CLI reference signals for CLI mitigation, in accordance with the present disclosure.

FIGS. 11-14 are diagrams illustrating example processes associated with transmitting inter-UE CLI reference signals for CLI mitigation, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

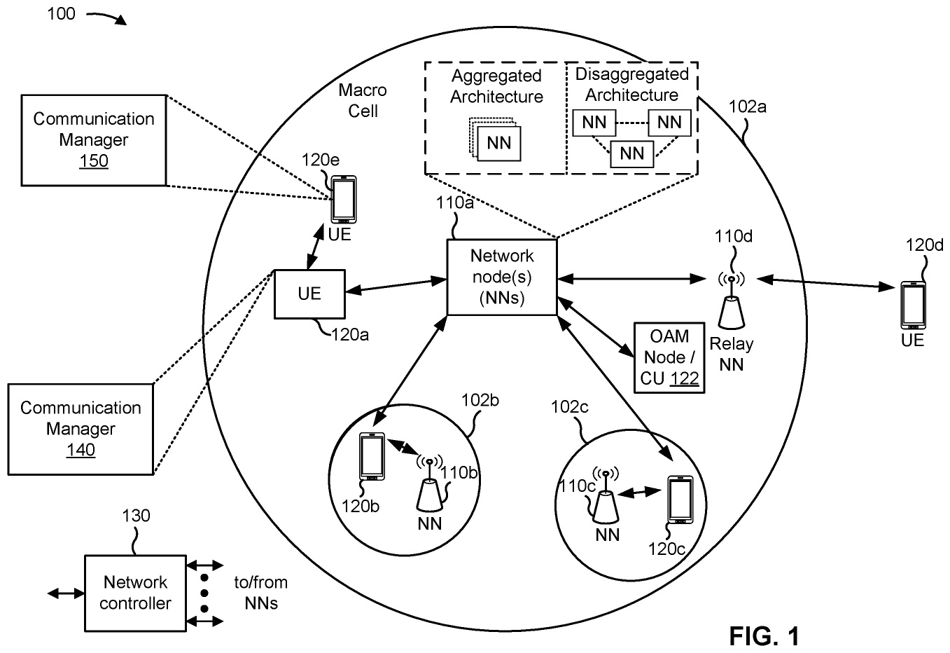

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may receive, from a first network node associated with the first UE, a cross-link interference (CLI) configuration; and transmit, to a second UE, an inter-UE CLI measurement reference signal based at least in part on the CLI configuration, a measurement associated with the inter-UE CLI measurement reference signal being signaled to the first network node. Additionally, or alternatively, the communication manager 140 may perform one or more other operations described herein.

In some aspects, the communication manager 140 may receive, from a second UE, an inter-UE CLI measurement reference signal, the inter-UE CLI measurement reference signal being associated with a CLI configuration, and a channel between the first UE and the second UE being associated with a channel reciprocity; and transmit, to a first network node associated with the first UE, a measurement associated with the inter-UE CLI measurement reference signal. Additionally, or alternatively, the communication manager 140 may perform one or more other operations described herein.

In some aspects, a second UE (e.g., UE 120e) may include a communication manager 150. As described in more detail elsewhere herein, the communication manager 150 may receive, from a first UE, an inter-UE CLI measurement reference signal, the inter-UE CLI measurement reference signal being associated with a CLI configuration; and transmit, to a first network node associated with the first UE via a second network node associated with the second UE, a measurement associated with the inter-UE CLI measurement reference signal. Additionally, or alternatively, the communication manager 150 may perform one or more other operations described herein.

In some aspects, the communication manager 150 may receive, from a second network node associated with the second UE, a CLI configuration; and transmit, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity. Additionally, or alternatively, the communication manager 150 may perform one or more other operations described herein.

As indicated above, FIG. 1 is provided as an example. Other examples may differ from what is described with regard to FIG. 1.

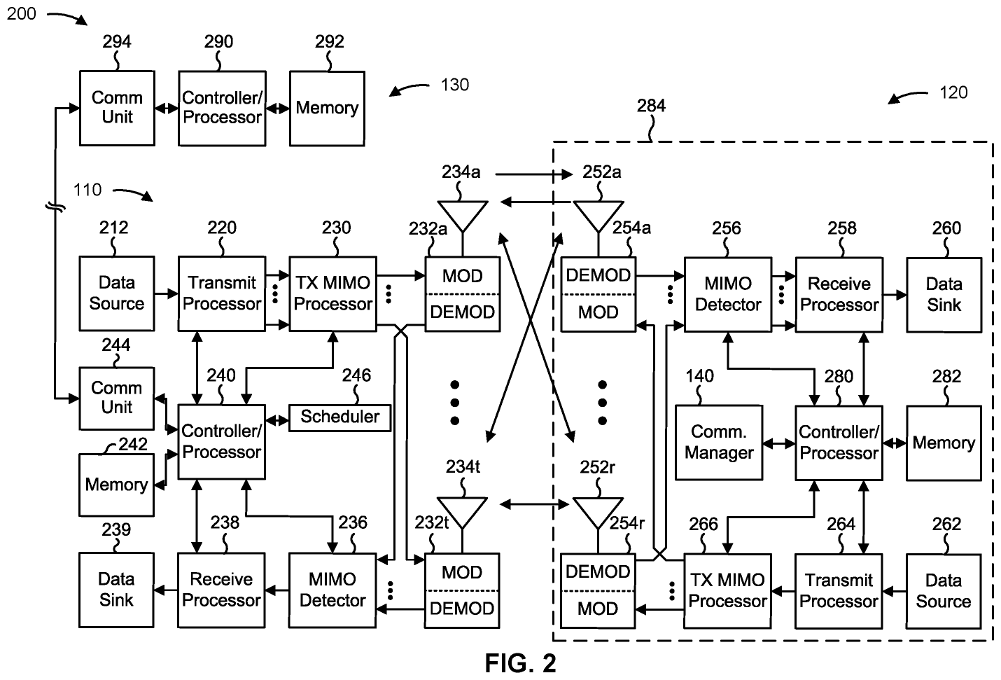

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

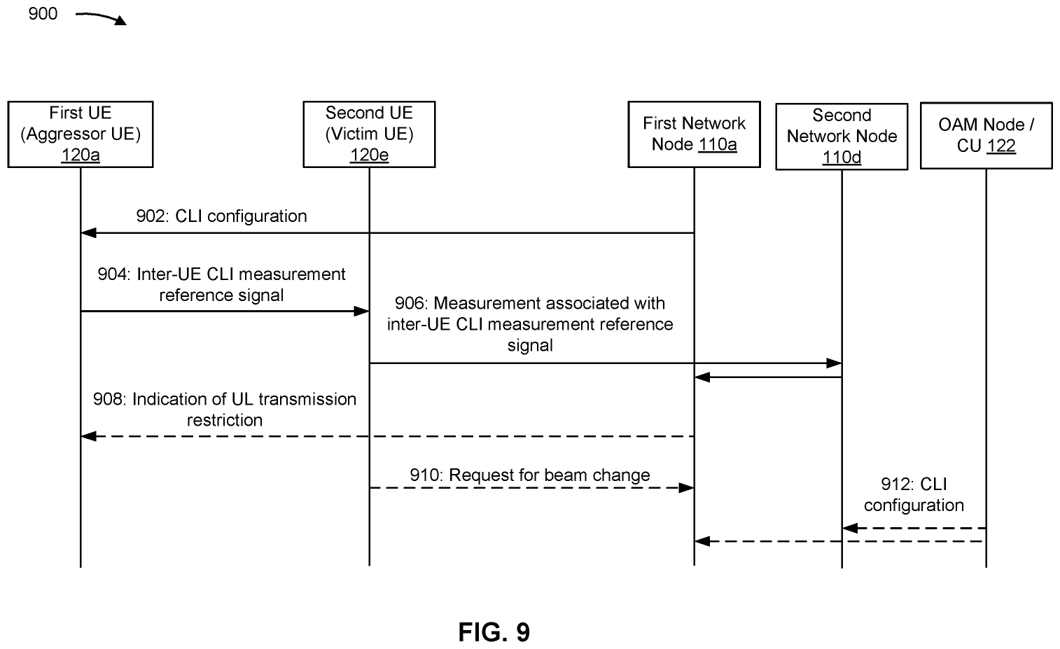

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-16).

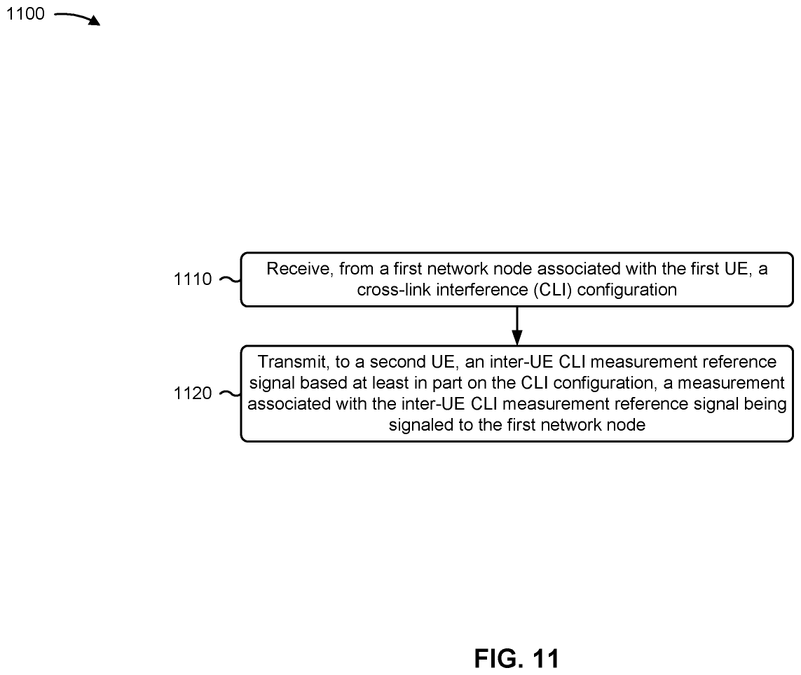

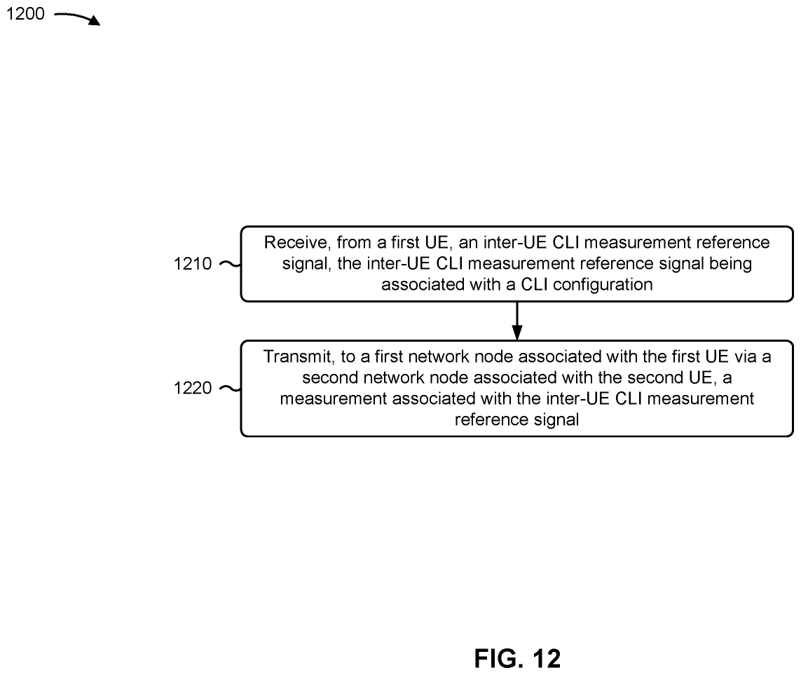

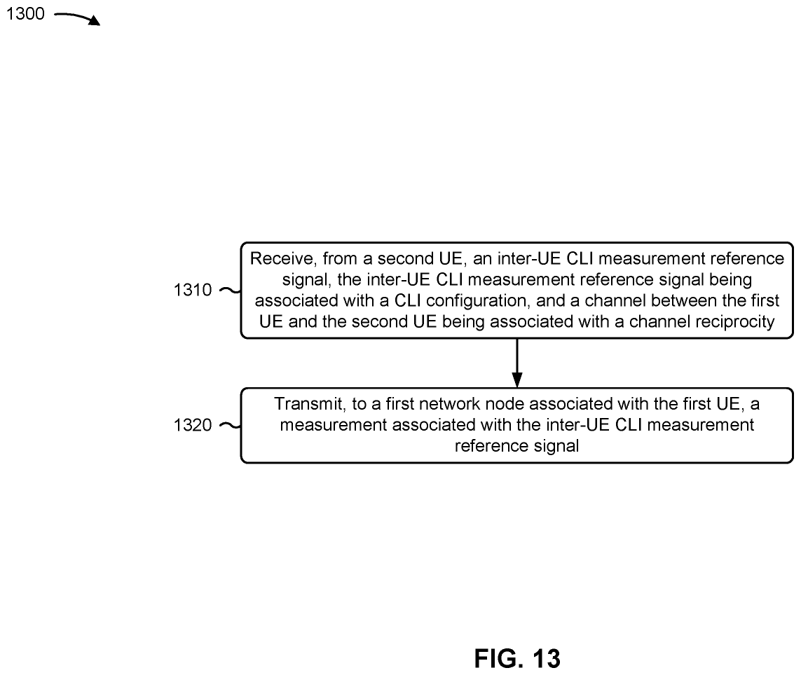

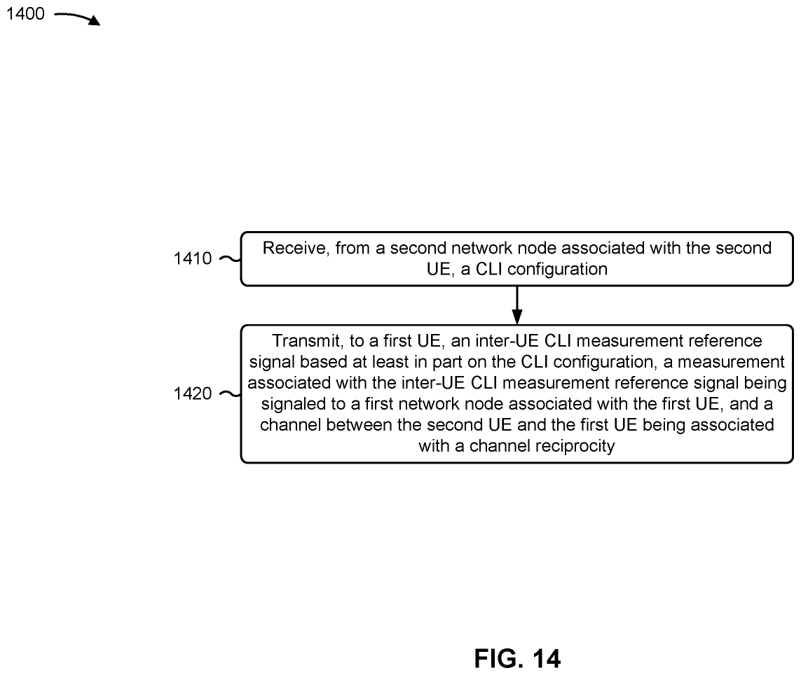

The controller/processor 240 of the network node 110, the controller/processor 280 of the UE 120, and/or any other component(s) of FIG. 2 may perform one or more techniques associated with transmitting inter-UE CLI reference signals for CLI mitigation, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving, from a first network node associated with the first UE, a CLI configuration; and/or means for transmitting, to a second UE, an inter-UE CLI measurement reference signal based at least in part on the CLI configuration, a measurement associated with the inter-UE CLI measurement reference signal being signaled to the first network node. In some aspects, the means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120e) includes means for receiving, from a first UE, an inter-UE CLI measurement reference signal, the inter-UE CLI measurement reference signal being associated with a CLI configuration; and/or means for transmitting, to a first network node associated with the first UE via a second network node associated with the second UE, a measurement associated with the inter-UE CLI measurement reference signal. In some aspects, the means for the apparatus to perform operations described herein may include, for example, one or more of communication manager 150, antenna 252, modem 254, MIMO detector 256, receive processor 258, transmit processor 264, TX MIMO processor 266, controller/processor 280, or memory 282.

In some aspects, a first UE (e.g., UE 120a) includes means for receiving, from a second UE, an inter-UE CLI measurement reference signal, the inter-UE CLI measurement reference signal being associated with a CLI configuration, and a channel between the first UE and the second UE being associated with a channel reciprocity; and/or means for transmitting, to a first network node associated with the first UE, a measurement associated with the inter-UE CLI measurement reference signal. In some aspects, the means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120e) includes means for receiving, from a second network node associated with the second UE, a CLI configuration; and/or means for transmitting, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity. In some aspects, the means for the apparatus to perform operations described herein may include, for example, one or more of communication manager 150, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

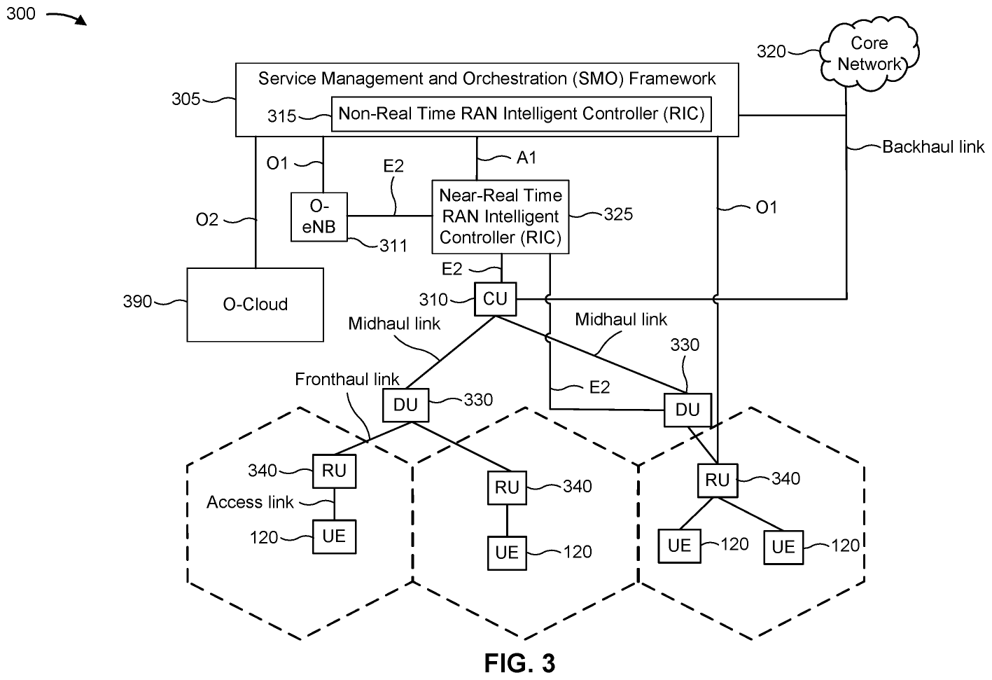

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a subband full duplex (SBFD) operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

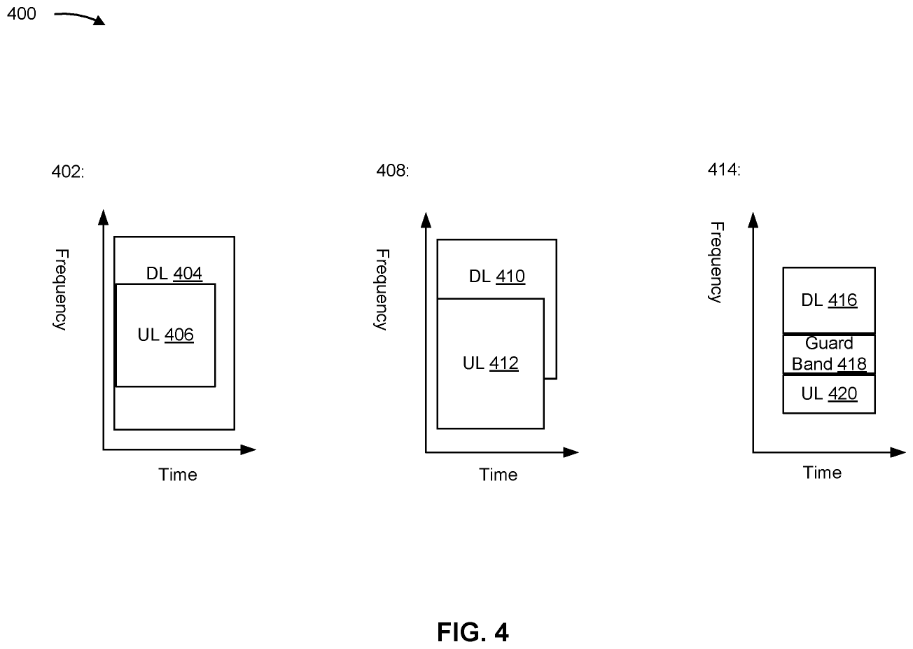

FIG. 4 is a diagram illustrating examples 400 of FD communications, in accordance with the present disclosure.

As shown by reference number 402, a downlink resource 404 and an uplink resource 406 may share the same IBFD time/frequency resource based at least in part on a full overlap. As shown by reference number 408, a downlink resource 410 and an uplink resource 412 may share the same IBFD time/frequency resource based at least in part on a partial overlap. As shown by reference number 414, a downlink resource 416 and an uplink resource 420 may be associated with a same time but different frequencies. The downlink resource 416 and the uplink resource 420 may be separated by a guard band 418.

As indicated above, FIG. 4 is provided as an example. Other examples may differ from what is described with regard to FIG. 4.

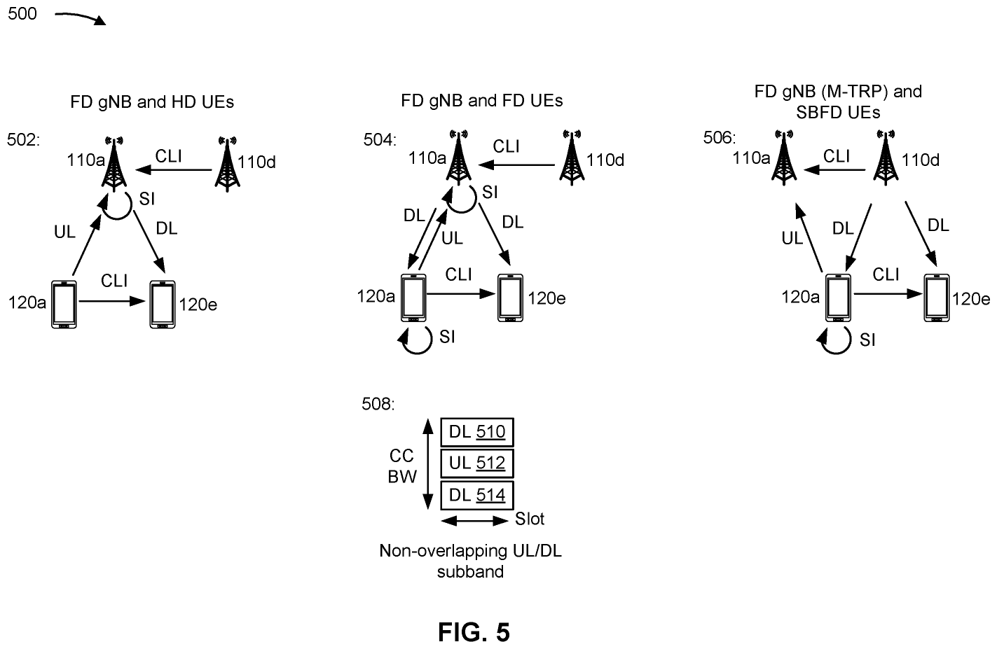

FIG. 5 is a diagram illustrating examples 500 of FD communications, in accordance with the present disclosure.

As shown by reference number 502, an FD network node (e.g., network node 110a) may communicate with half duplex (HD) UEs. The FD network node may be subjected to CLI from another FD network node (e.g., network node 110d). The CLI from the other FD network node may be inter-network node CLI. The FD network node may experience self-interference (SI). The FD network node may receive an uplink transmission from a first HD UE (e.g., UE 120a), and the FD network node may transmit a downlink transmission to a second HD UE (e.g., UE 120e). The FD network node may receive the uplink transmission and transmit the downlink transmission on the same slot (e.g., a simultaneous reception/transmission). The second HD UE may be subjected to CLI from the first HD UE (e.g., inter-UE CLI).

As shown by reference number 504, an FD network node (e.g., network node 110a) may communicate with FD UEs. The FD network node may be subjected to CLI from another FD network node (e.g., network node 110d). The FD network node may experience SI. The FD network node may transmit a downlink transmission to a first FD UE (e.g., UE 120a), and the FD network node may receive an uplink transmission from the first FD UE at the same time as the downlink transmission. The FD network node may transmit a downlink transmission to a second FD UE (e.g., UE 120e). The second HD UE may be subjected to CLI from the first HD UE. The first UE may experience SI.

As shown by reference number 506, a first FD network node (e.g., network node 110a), which may be associated with multiple TRPs, may communicate with SBFD UEs. The first FD network node may be subjected to CLI from a second FD network node (e.g., network node 110s). The first FD network node may receive an uplink transmission from a first SBFD UE (e.g., UE 120a). The second FD network node may transmit downlink transmissions to both the first SBFD UE and a second SBFD UE (e.g., UE 120e). The second SBFD UE may be subjected to CLI from the first SBFD UE. The first SBFD UE may experience SI.

As shown by reference number 508, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 512 may be in between, in a frequency domain, a first downlink resource 510 and a second downlink resource 514. The first downlink resource 510, the second downlink resource 514, and the uplink resource 512 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 5 is provided as an example. Other examples may differ from what is described with regard to FIG. 5.

When a UE is operating in an HD mode and a network node is operating in an SBFD/IBFD mode, various sources of interference may be present for the UE. The UE may experience inter-cell interference from other network nodes. The UE may experience intra-cell CLI, which may be interference from UEs in the same cell. The UE may experience inter-cell CLI, which may be interference from UEs in adjacent cells. Further, when the UE is an FD UE, the UE may experience SI (e.g., a downlink transmission of the UE may cause interference to an uplink transmission associated with the UE, or vice versa). Inter-UE CLI handling may resolve intra-subband CLI and/or inter-subband CLI in the case of subband non-overlapping FD.

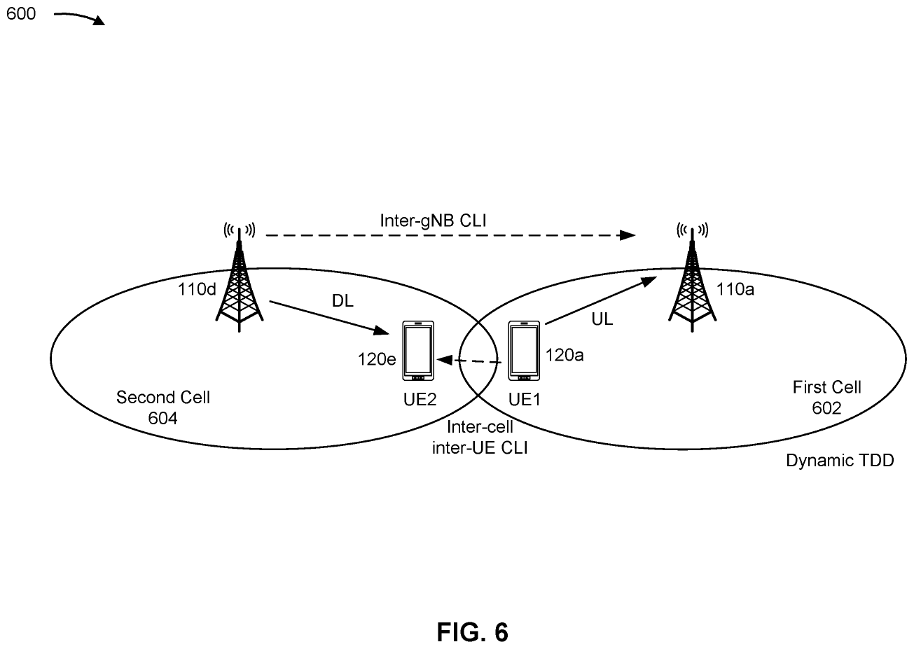

FIG. 6 is a diagram illustrating an example 600 of CLI, in accordance with the present disclosure.

As shown in FIG. 6, in a dynamic time domain duplexing (TDD) scenario, a first network node 110a in a first cell 602 may receive an uplink transmission from a first UE 120a. A second network node 110d in a second cell 604 may transmit a downlink transmission to a second UE 120e. The second UE 120e may experience interference from the first UE 120a. In other words, the first UE 120a may cause interference to the second UE 120e, where the interference may be based at least in part on the uplink transmission from the first UE 120a. The interference may be an inter-cell inter-UE CLI. Further, the first network node 110a may experience inter-network-node (e.g., inter-gNB) CLI from the second network node 110d.

As indicated above, FIG. 6 is provided as an example. Other examples may differ from what is described with regard to FIG. 6.

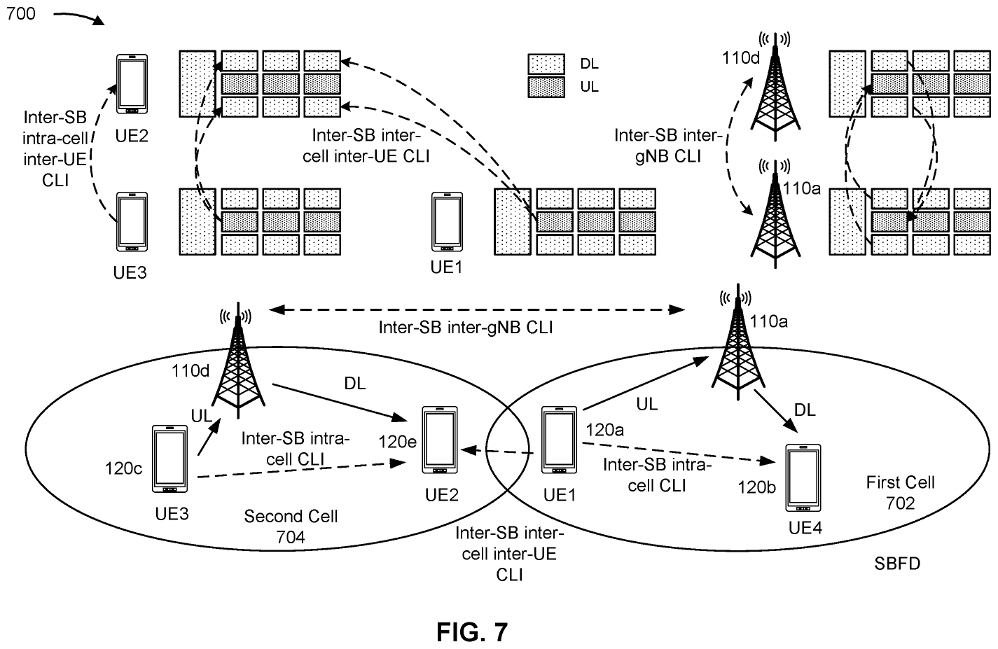

FIG. 7 is a diagram illustrating an example 700 of CLI, in accordance with the present disclosure.

As shown in FIG. 7, in an SBFD scenario, a first network node 110a in a first cell 702 may receive an uplink transmission from a first UE 120a in the first cell 702. The first network node 110a may transmit a downlink transmission to a fourth UE 120b in the first cell 702. The first UE 120a may cause an inter-subband (inter-SB) intra-cell CLI to the fourth UE 120b based at least in part on the uplink transmission of the first UE 120a. A second network node 110d in a second cell 704 may receive an uplink transmission from a third UE 120c in the second cell 704. The second network node 110d may transmit a downlink transmission to a second UE 120e in the second cell 704. The third UE 120c may cause an inter-SB intra-cell CLI to the second UE 120e based at least in part on the uplink transmission of the third UE 120c. The uplink transmission of the third UE 120c may cause the inter-SB intra-cell CLI to downlink transmissions of the second UE 120e. Further, the first UE 120a in the first cell 702 may cause an inter-SB inter-cell inter-UE CLI to the second UE 120e in the second cell 704 based at least in part on the uplink transmission of the first UE 120a. The uplink transmission of the first UE 120a may cause the inter-SB inter-cell inter-UE CLI to downlink transmissions of the second UE 120e. Further, the first network node 110a may cause an inter-SB inter-gNB CLI to the second network node 110d, and vice versa. Downlink transmissions of the first network node 110a may cause the inter-SB inter-gNB CLI to an uplink transmission of the second network node 110d. Downlink transmissions of the second network node 110d may cause the inter-SB inter-gNB CLI to an uplink transmission of the first network node 110a.

As indicated above, FIG. 7 is provided as an example. Other examples may differ from what is described with regard to FIG. 7.

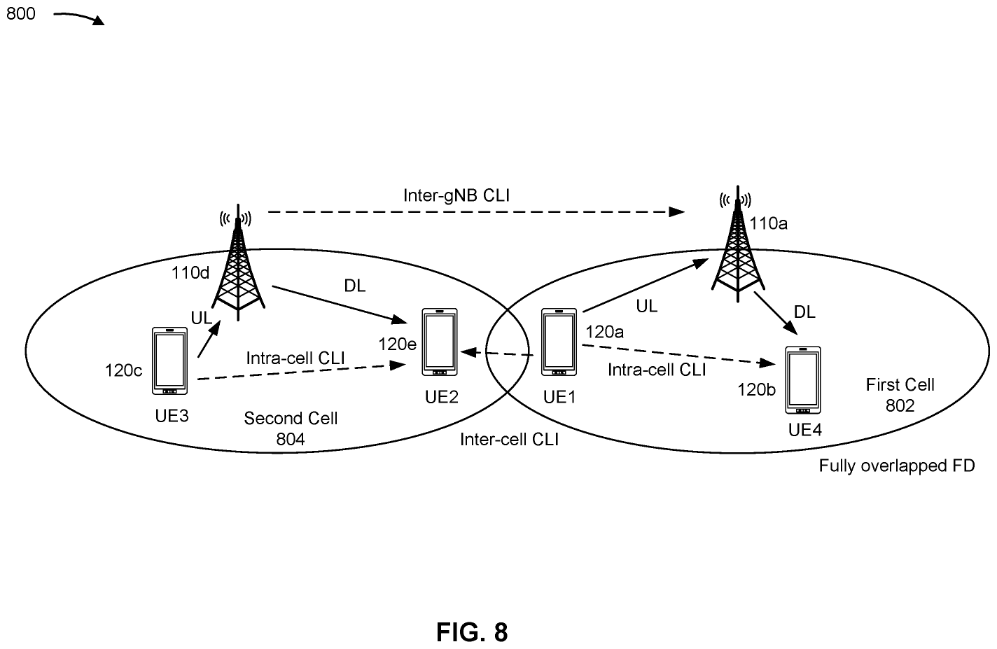

FIG. 8 is a diagram illustrating an example 800 of CLI, in accordance with the present disclosure.

As shown in FIG. 8, in a fully overlapped FD scenario, a first network node 110a in a first cell 802 may receive an uplink transmission from a first UE 120a in the first cell 802. The first network node 110a may transmit a downlink transmission to a fourth UE 120b in the first cell 802. The first UE 120a may cause an intra-cell CLI to the fourth UE 120b based at least in part on the uplink transmission of the first UE 120a. A second network node 110d in a second cell 804 may receive an uplink transmission from a third UE 120c in the second cell 804. The second network node 110d may transmit a downlink transmission to a second UE 120e in the second cell 804. The third UE 120c may cause an intra-cell CLI to the second UE 120e based at least in part on the uplink transmission of the third UE 120c. Further, the first UE 120a in the first cell 702 may cause an inter-cell CLI to the second UE 120e in the second cell 804 based at least in part on the uplink transmission of the first UE 120a. Further, the first network node 110a may cause an in-band inter-gNB CLI to the second network node 110d, and vice versa.

As indicated above, FIG. 8 is provided as an example. Other examples may differ from what is described with regard to FIG. 8.

Inter-UE CLI mitigation may be needed for dynamic TDD scenarios. Inter-UE CLI mitigation may be needed for subband non-overlapping FD scenarios and partial or fully overlapping FD scenarios. In such scenarios, to enable inter-UE CLI mitigation, coordinated scheduling for time and/or frequency resources between network nodes may need to be defined for UE-to-UE co-channel CLI scheduling. The coordinated scheduling may be specific for dynamic/flexible TDD, and/or common for both SBFD and dynamic/flexible TDD. Network nodes and/or UEs may need to be configured for such coordinated signaling in order to enable inter-UE CLI mitigation.

In various aspects of techniques and apparatuses described herein, a first UE (e.g., an aggressor UE) may transmit an inter-UE CLI measurement reference signal, which may be received and measured by a second UE (e.g., a victim UE). The first UE may perform an uplink transmission restriction for inter-UE CLI reduction between the first UE and the second UE, where the uplink transmission restriction may be based at least in part on a measurement of the inter-UE CLI measurement reference signal. In some aspects, the second UE may transmit the inter-UE CLI measurement reference signal, which may be received and measured by the first UE. The first UE may perform an uplink transmission decision based at least in part on a measurement of the inter-UE CLI measurement reference signal. In both cases, the inter-UE CLI measurement reference signal may be configured via an operations, administration, and maintenance (OAM) node or a CU, which may be signaled via a backhaul or OTA. In other words, a configuration associated with the inter-UE CLI measurement reference signal may be applied across network nodes. As a result, an inter-UE CLI mitigation may be achieved via a coordinated scheduling between the network nodes.

FIG. 9 is a diagram illustrating an example 900 associated with transmitting inter-UE CLI reference signals for CLI mitigation. As shown in FIG. 9, example 900 includes communication between a first UE (e.g., UE 120a), a second UE (e.g., UE 120e), a first network node (e.g., network node 110a), a second network node (e.g., network node 110d), and an OAM node/CU 122. In some aspects, the first UE, the second UE, the first network node, the second network node, and the OAM node/CU may be included in a wireless network, such as wireless network 100.

In some aspects, the first UE may be an aggressor UE because the first UE may subject the second UE to inter-UE CLI. In other words, the first UE may be the aggressor because the first UE causes the inter-UE CLI for the second UE. The second UE may be a victim UE because the second UE may be subjected to the inter-UE CLI from the first UE. In other words, the second UE may be the victim because the second UE is affected by the inter-UE CLI from the first UE.

As shown by reference number 902, the first UE may receive, from the first network node associated with the first UE, a CLI configuration. The CLI configuration may configure the first UE to transmit an inter-UE CLI measurement reference signal. In some aspects, the first network node may be configured with the CLI configuration. The first network node may be configured with the CLI configuration via an OAM node or a CU. In other words, the OAM node or the CU may transmit the CLI configuration to the first network node. The CLI configuration may be associated with a backhaul signaling or an OTA signaling. In other words, the CLI configuration may be signaled via a backhaul or via OTA. The CLI configuration, which may be from the OAM node or the CU, may support coordinated scheduling between network nodes, such as the first network node and the second network node.

In some aspects, the CLI configuration may indicate inter-UE CLI transmission parameters. The inter-UE CLI transmission parameters may be associated with the inter-UE CLI measurement reference signal transmitted by the first UE. The inter-UE CLI transmission parameters may include a time location, a frequency location, a reference signal sequence identifier (ID), beam information, and/or a periodicity associated with inter-UE CLI transmissions (e.g., transmissions of inter-UE CLI measurement reference signals), which may vary between different UEs of different cells or different network nodes. In other words, the OAM node or the CU may configure the inter-UE CLI transmission parameters, which may indicate the time location, the frequency location, the reference sequence ID, the beam information, and/or the periodicity associated with inter-UE CLI transmissions. The inter-UE CLI transmission parameters may be signaled via the backhaul signaling or via the OTA signaling. In some aspects, the CLI configuration may indicate inter-UE CLI monitoring parameters. The inter-UE CLI monitoring parameters may include a monitoring window location and/or a periodicity associated with an inter-UE CLI monitoring, which may vary between different UEs of different cells or different network nodes. In other words, the OAM node or the CU may configure the inter-UE CLI monitoring parameters, which may include the monitoring window location and/or the periodicity associated with the inter-UE CLI monitoring. The inter-UE CLI monitoring parameters may be signaled via the backhaul signaling or via the OTA signaling.

As shown by reference number 904, the first UE may transmit, to the second UE, the inter-UE CLI measurement reference signal based at least in part on the CLI configuration. The inter-UE CLI measurement reference signal may be a sounding reference signal (SRS). The first UE may transmit the inter-UE CLI measurement reference signal to the second UE for measurement by the second UE. In some aspects, the inter-UE CLI measurement reference signal may indicate a transmitting UE ID and/or a transmitting CLI resource ID to distinguish between different aggressor UEs. In other words, the inter-UE CLI measurement reference signal may be configured to include the transmitting UE ID and/or the transmitting CLI resource ID to distinguish between the different aggressor UEs, where the configuring of the transmitting UE ID and/or the transmitting CLI resource ID may be from the OAM node or the CU via the backhaul signaling or the OTA signaling. In some aspects, the inter-UE CLI measurement reference signal may be code division multiplexed across multiple transmitting UEs. In other words, the inter-UE CLI measurement reference signal may be configured as code division multiplexed across the multiple transmitting UEs to save resources, where the configuring of the inter-UE CLI measurement reference signal that is code division multiplexed may be from the OAM node or the CU via the backhaul signaling or the OTA signaling.

In some aspects, the second UE may receive the inter-UE CLI measurement reference signal from the first UE. In some aspects, the second UE may receive the CLI configuration from the second network node, where the CLI configuration may configure the second UE to receive and measure the inter-UE CLI measurement reference signal. The second network node may receive the CLI configuration from the OAM node or the CU.

As shown by reference number 906, the second UE may transmit the measurement associated with the inter-UE CLI measurement reference signal received from the first UE. The second UE may transmit the measurement to the first network node via the second network node associated with the second UE. The first network node may perform scheduling decisions based at least in part on the measurement associated with the inter-UE CLI measurement reference signal.

As shown by reference number 908, the first UE may receive, from the first network node, an indication of an uplink transmission restriction. The uplink transmission restriction may be based at least in part on the measurement associated with the inter-UE CLI measurement reference signal. The first UE may perform the uplink transmission restriction based at least in part on the indication received from the first network node. In other words, the uplink transmission restriction may be implemented at the first network node's first UE (e.g., the aggressor UE) for inter-UE CLI reduction.

As shown by reference number 910, the second UE may transmit, to the second network node and based at least in part on the measurement associated with the inter-UE CLI measurement reference signal, a request for a beam change to reduce inter-UE CLI. The request may indicate a new candidate beam. The second network node may grant the request from the second UE. The second UE may subsequently perform transmissions using the new candidate beam, which may result in the first UE no longer causing inter-UE CLI to the second UE.

As shown by reference number 912, the OAM node/CU may transmit the CLI configuration to the first network node and the second network node. “OAM node /CU” may refer to an OAM node or a CU. The OAM node/CU may transmit the same CLI configuration to both the first network node and the second network node, such that UEs associated with the first network node and the second network node may receive the same CLI configuration. Inter-UE CLI measurement reference signals may be transmitted using the same CLI configuration, which may achieve inter-UE CLI mitigation via coordinated scheduling between network nodes. The inter-UE CLI measurement reference signals may be configured to be transmitted and measured via the OAM node/CU.

In some aspects, a signaling of an inter-UE CLI measurement report between the first network node and the second network node may be based at least in part on an event trigger, where the event trigger may occur based at least in part on an inter-UE CLI level between the first network node and the second network node satisfying a threshold. In some aspects, an inter-UE CLI measurement report signaled between the first network node and the second network node may include an aggressor UE ID, a CLI resource ID, corresponding UE future data or control scheduling information, a suggested UE power backoff value, beam information, and/or an indication of time-frequency resources.

In some aspects, inter-UE CLI mitigation may be achieved via coordinated scheduling between network nodes, such as the first network node and the second network node. The inter-UE CLI measurement reference signal may be configured and transmitted by the first UE (e.g., the first network node's aggressor UE). The inter-UE CLI measurement reference signal may be measured by the second UE (e.g., the second network node's victim UE). The second UE may measure the inter-UE CLI measurement reference signal, and the second UE may signal a measurement result associated with the inter-UE CLI measurement reference signal to the first network node via the second network node. For example, the second UE may transmit the measurement result to the second network node, and the second network node may forward the measurement result to the first network node. In some aspects, depending on the measurement result, the uplink transmission restriction may be implemented at the first UE for inter-UE CLI reduction between UEs associated with different network nodes (e.g., between the first UE and the second UE associated with the first network node and the second network node, respectively). In some aspects, depending on the measurement result, the second UE may request the second network node for the beam change in order to reduce CLI, where the request may indicate the new candidate beam. In some aspects, the inter-UE CLI measurement reference signal may be configured via the OAM node or the CU using backhaul signaling or OTA signaling.

In some aspects, the signaling of the inter-UE CLI measurement report between the first network node and the second network node may be event triggered. For example, when an inter-UE CLI level between the first network node and the second network node satisfies a threshold, the inter-UE CLI reporting signaling may be triggered between the first network node and the second network node. Otherwise, no report signaling may be triggered in order to save signaling overhead. The signaling of the inter-UE CLI measurement report between the first network node and the second network node may be via the backhaul signaling or the OTA signaling. In some aspects, the signaling of the inter-UE CLI measurement report between the first network node and the second network node may include additional assistance information. The assistance information may indicate the aggressor UE ID, the CLI resource ID, a respective UE's future data and/or control scheduling information (which may aid a network node when performing a UE scheduling decision to avoid inter-cell CLI), the suggested UE power backoff value, the beam information (e.g., beam ID), and/or certain time and/or frequency resources for performing inter-UE CLI measurements or transmitting the inter-UE CLI measurement report. The signaling of the assistance information may be via the backhaul signaling or the OTA signaling.

As indicated above, FIG. 9 is provided as an example. Other examples may differ from what is described with regard to FIG. 9.

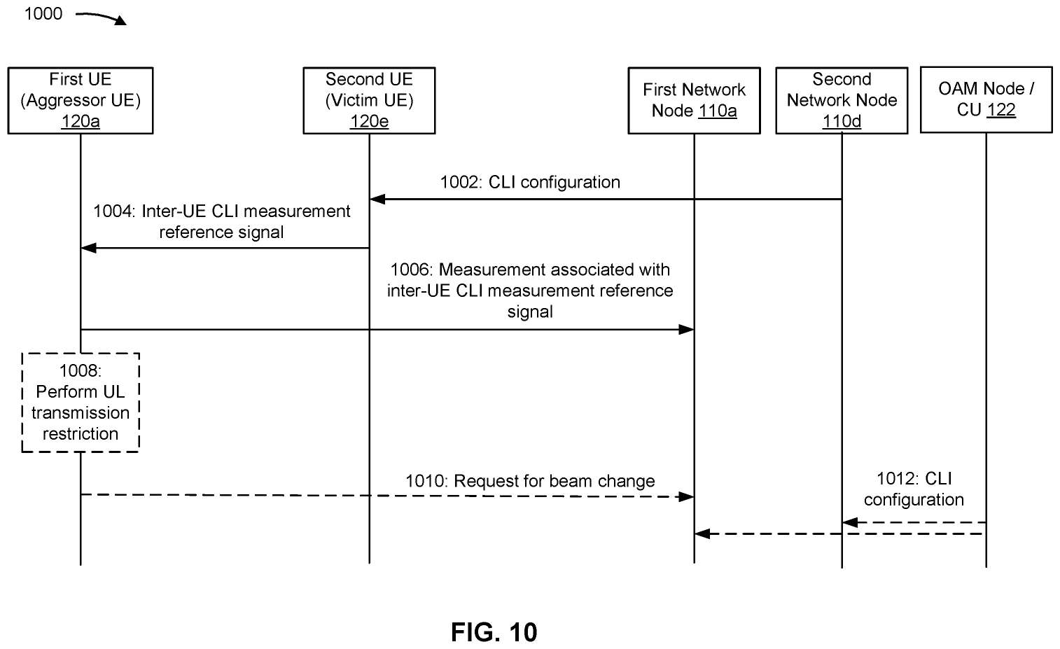

FIG. 10 is a diagram illustrating an example 1000 associated with transmitting inter-UE CLI reference signals for CLI mitigation. As shown in FIG. 10, example 1000 includes communication between a first UE (e.g., UE 120a), a second UE (e.g., UE 120e), a first network node (e.g., network node 110a), a second network node (e.g., network node 110d), and an OAM node/CU 122. In some aspects, the first UE, the second UE, the first network node, the second network node, and the OAM node/CU 122 may be included in a wireless network, such as wireless network 100.

In some aspects, the first UE may be an aggressor UE because the first UE may subject the second UE to inter-UE CLI. In other words, the first UE may be the aggressor because the first UE causes the inter-UE CLI for the second UE. The second UE may be a victim UE because the second UE may be subjected to the inter-UE CLI from the first UE. In other words, the second UE may be the victim because the second UE is affected by the inter-UE CLI from the first UE.

As shown by reference number 1002, the second UE may receive, from the second network node associated with the second UE, a CLI configuration. The CLI configuration may configure the second UE to transmit an inter-UE CLI measurement reference signal. In some aspects, the second network node may be configured with the CLI configuration. The second network node may be configured with the CLI configuration via an OAM node or a CU. In other words, the OAM node or the CU may transmit the CLI configuration to the second network node. The CLI configuration may be associated with a backhaul signaling or an OTA signaling. In other words, the CLI configuration may be signaled via a backhaul or via OTA. The CLI configuration, which may be from the OAM node or the CU, may support coordinated scheduling between network nodes, such as the first network node and the second network node.

As shown by reference number 1004, the second UE may transmit, to the first UE, the inter-UE CLI measurement reference signal based at least in part on the CLI configuration. The second UE may transmit the inter-UE CLI measurement reference signal to the first UE for measurement by the first UE. A channel between the second UE and the first UE may be associated with a channel reciprocity. The first UE may receive, from the second UE, the inter-UE CLI measurement reference signal.

As shown by reference number 1006, the first UE may transmit, to the first network node associated with the first UE, a measurement associated with the inter-UE CLI measurement reference signal. In some aspects, the first UE may receive the CLI configuration from the first network node, where the CLI configuration may configure the first UE to receive and measure the inter-UE CLI measurement reference signal. The CLI configuration may also configure the first UE to report the measurement associated with the inter-UE CLI measurement reference signal.

As shown by reference number 1008, the first UE may perform an uplink transmission restriction, which may be based at least in part on the measurement associated with the inter-UE CLI measurement reference signal. For example, the first UE may determine an amount of inter-UE CLI caused to the second UE based at least in part on the measurement associated with the inter-UE CLI measurement reference signal. The first UE may perform the uplink transmit restriction based at least in part on the amount of inter-UE CLI caused to the second UE.

As shown by reference number 1010, the first UE may transmit, to the first network node and based at least in part on the measurement associated with the inter-UE CLI measurement reference signal, a request for a beam change to reduce inter-UE CLI. The request indicates a new candidate beam. The first network node may grant the request from the first UE. The first UE may subsequently perform transmissions using the new candidate beam, which may result in the first UE no longer causing inter-UE CLI to the second UE.

As shown by reference number 1012, the OAM node/CU may transmit the CLI configuration to the first network node and the second network node. The OAM node/CU may transmit the same CLI configuration to both the first network node and the second network node, such that UEs associated with the first network node and the second network node may receive the same CLI configuration. Inter-UE CLI measurement reference signals may be transmitted using the same CLI configuration, which may achieve inter-UE CLI mitigation via coordinated scheduling between network nodes. The inter-UE CLI measurement reference signals may be configured to be transmitted and measured via the OAM node/CU.

In some aspects, inter-UE CLI mitigation may be achieved via coordinated scheduling between network nodes, such as the first network node and the second network node. The inter-UE CLI measurement reference signal may be configured and transmitted by the second UE (e.g., the second network node's victim UE). The inter-UE CLI measurement reference signal may be measured by the first UE (e.g., the first network node's aggressor UE). The channel reciprocity may exist between the first UE and the second UE. The first UE may measure the inter-UE CLI measurement reference signal, and the first UE may signal a measurement result associated with the inter-UE CLI measurement reference signal to the first network node. In some aspects, depending on the measurement result, the first UE may derive the caused inter-UE CLI to the second UE, and a corresponding uplink transmission decision may be performed. For example, when an amount of inter-UE CLI is relatively high, low priority uplink transmissions may be held at the second UE. In some aspects, depending on the measurement result, the first UE may request the first network node for the beam change in order to reduce CLI, where the request may indicate the new candidate beam. In some aspects, the inter-UE CLI measurement reference signal may be configured via the OAM node or the CU using backhaul signaling or OTA signaling.

As indicated above, FIG. 10 is provided as an example. Other examples may differ from what is described with regard to FIG. 10.

FIG. 11 is a diagram illustrating an example process 1100 performed, for example, by a first UE, in accordance with the present disclosure. Example process 1100 is an example where the first UE (e.g., first UE 120a) performs operations associated with transmitting inter-UE CLI reference signals for CLI mitigation.

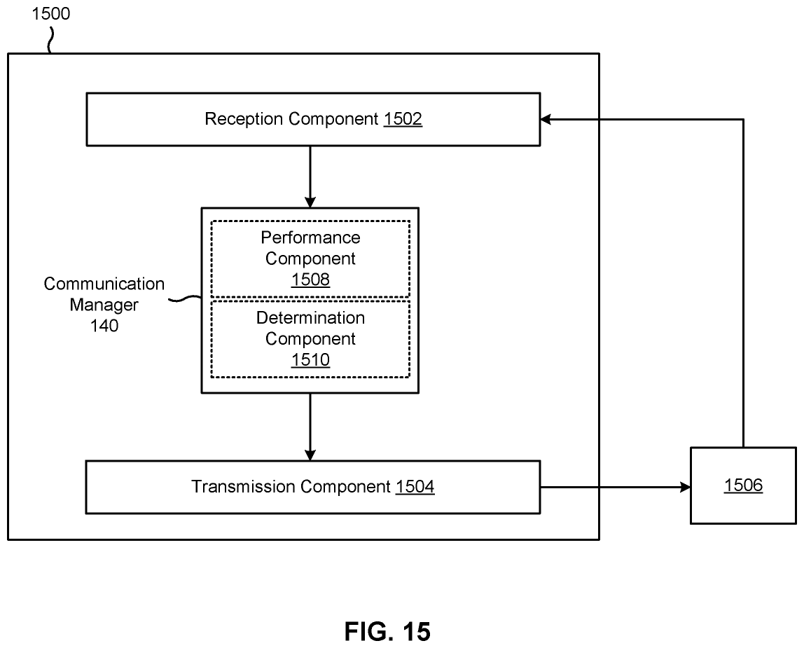

As shown in FIG. 11, in some aspects, process 1100 may include receiving, from a first network node associated with the first UE, a CLI configuration (block 1110). For example, the first UE (e.g., using communication manager 140 and/or reception component 1502, depicted in FIG. 15) may receive, from a first network node associated with the first UE, a CLI configuration, as described above.

As further shown in FIG. 11, in some aspects, process 1100 may include transmitting, to a second UE, an inter-UE CLI measurement reference signal based at least in part on the CLI configuration, a measurement associated with the inter-UE CLI measurement reference signal being signaled to the first network node (block 1120). For example, the first UE (e.g., using communication manager 140 and/or transmission component 1504, depicted in FIG. 15) may transmit, to a second UE, an inter-UE CLI measurement reference signal based at least in part on the CLI configuration, a measurement associated with the inter-UE CLI measurement reference signal being signaled to the first network node, as described above.

Process 1100 may include additional aspects, such as any single aspect or any combination of aspects described below and/or in connection with one or more other processes described elsewhere herein.

In a first aspect, the first UE is an aggressor UE and the second UE is a victim UE.

In a second aspect, alone or in combination with the first aspect, process 1100 includes receiving, from the first network node, an indication of an uplink transmission restriction, wherein the uplink transmission restriction is based at least in part on the measurement associated with the inter-UE CLI measurement reference signal, and process 1100 includes performing the uplink transmission restriction based at least in part on the indication received from the first network node.

In a third aspect, alone or in combination with one or more of the first and second aspects, the CLI configuration is via an OAM node or a CU, and the CLI configuration is associated with a backhaul signaling or an OTA signaling.

In a fourth aspect, alone or in combination with one or more of the first through third aspects, the inter-UE CLI measurement reference signal indicates a transmitting UE identifier or a transmitting CLI resource identifier to distinguish between different aggressor UEs.

In a fifth aspect, alone or in combination with one or more of the first through fourth aspects, the inter-UE CLI measurement reference signal is code division multiplexed across multiple transmitting UEs.

In a sixth aspect, alone or in combination with one or more of the first through fifth aspects, the CLI configuration indicates inter-UE CLI transmission parameters, and the inter-UE CLI transmission parameters include one or more of a time location, a frequency location, a reference signal sequence identifier, beam information, or a periodicity between different UEs of different cells or different network nodes.

In a seventh aspect, alone or in combination with one or more of the first through sixth aspects, the CLI configuration indicates inter-UE CLI monitoring parameters, and the inter-UE CLI monitoring parameters include a monitoring window location and periodicity between different UEs of different cells or different network nodes.

In an eighth aspect, alone or in combination with one or more of the first through seventh aspects, a signaling of an inter-UE CLI measurement report between the first network node and the second network node is based at least in part on an event trigger, and the event trigger occurs based at least in part on an inter-UE CLI level between the first network node and the second network node satisfying a threshold.

In a ninth aspect, alone or in combination with one or more of the first through eighth aspects, an inter-UE CLI measurement report signaled between the first network node and the second network node includes one or more of an aggressor UE identifier, a CLI resource identifier, upcoming UE data or control scheduling information, a suggested UE power backoff value, beam information, or an indication of time-frequency resources.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a second UE, in accordance with the present disclosure. Example process 1200 is an example where the second UE (e.g., second UE 120e) performs operations associated with transmitting inter-UE CLI reference signals for CLI mitigation.

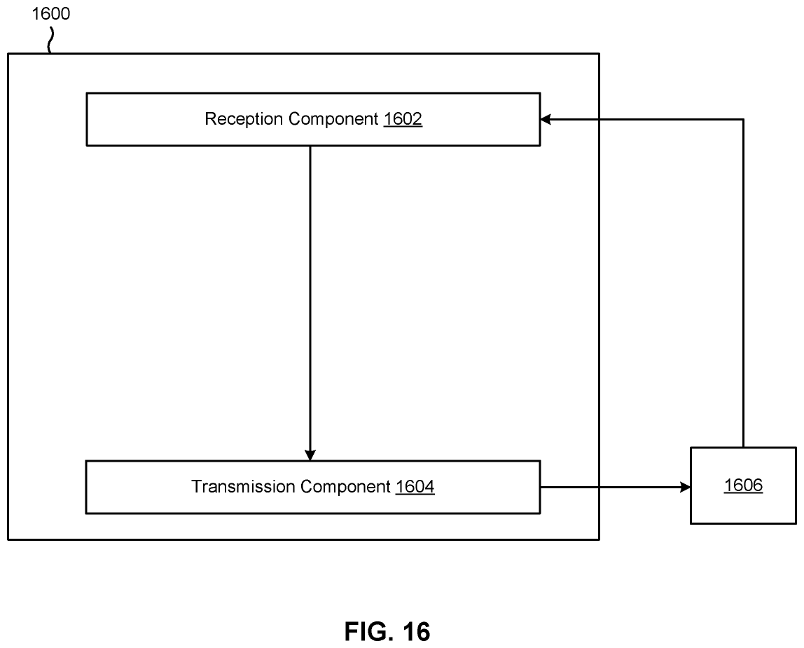

As shown in FIG. 12, in some aspects, process 1200 may include receiving, from a first UE, an inter-UE CLI measurement reference signal, the inter-UE CLI measurement reference signal being associated with a CLI configuration (block 1210). For example, the second UE (e.g., using reception component 1602, depicted in FIG. 16) may receive, from a first UE, an inter-UE CLI measurement reference signal, the inter-UE CLI measurement reference signal being associated with a CLI configuration, as described above.

As further shown in FIG. 12, in some aspects, process 1200 may include transmitting, to a first network node associated with the first UE via a second network node associated with the second UE, a measurement associated with the inter-UE CLI measurement reference signal (block 1220). For example, the second UE (e.g., using transmission component 1604, depicted in FIG. 16) may transmit, to a first network node associated with the first UE via a second network node associated with the second UE, a measurement associated with the inter-UE CLI measurement reference signal, as described above.

Process 1200 may include additional aspects, such as any single aspect or any combination of aspects described below and/or in connection with one or more other processes described elsewhere herein.

In a first aspect, the second UE is a victim UE and the first UE is an aggressor UE.

In a second aspect, alone or in combination with the first aspect, process 1200 includes transmitting, to the second network node and based at least in part on the measurement associated with the inter-UE CLI measurement reference signal, a request for a beam change to reduce inter-UE CLI, wherein the request indicates a new candidate beam.

In a third aspect, alone or in combination with one or more of the first and second aspects, the CLI configuration is via an OAM node or a CU, and the CLI configuration is associated with a backhaul signaling or an over-the-air signaling.

In a fourth aspect, alone or in combination with one or more of the first through third aspects, the inter-UE CLI measurement reference signal indicates a transmitting UE identifier or a transmitting CLI resource identifier to distinguish between different aggressor UEs.

In a fifth aspect, alone or in combination with one or more of the first through fourth aspects, the inter-UE CLI measurement reference signal is code division multiplexed across multiple transmitting UEs.

In a sixth aspect, alone or in combination with one or more of the first through fifth aspects, the CLI configuration indicates inter-UE CLI transmission parameters, and the inter-UE CLI transmission parameters include one or more of a time location, a frequency location, a reference signal sequence identifier, beam information, or a periodicity between different UEs of different cells or different network nodes.

In a seventh aspect, alone or in combination with one or more of the first through sixth aspects, the CLI configuration indicates inter-UE CLI monitoring parameters, and the inter-UE CLI monitoring parameters include a monitoring window location and periodicity between different UEs of different cells or different network nodes.

In an eighth aspect, alone or in combination with one or more of the first through seventh aspects, a signaling of an inter-UE CLI measurement report between the first network node and the second network node is based at least in part on an event trigger, and the event trigger occurs based at least in part on an inter-UE CLI level between the first network node and the second network node satisfying a threshold.

In a ninth aspect, alone or in combination with one or more of the first through eighth aspects, an inter-UE CLI measurement report signaled between the first network node and the second network node includes one or more of an aggressor UE identifier, a CLI resource identifier, upcoming UE data or control scheduling information, a suggested UE power backoff value, beam information, or an indication of time-frequency resources.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a first UE, in accordance with the present disclosure. Example process 1300 is an example where the first UE (e.g., first UE 120a) performs operations associated with transmitting inter-UE CLI reference signals for CLI mitigation.

As shown in FIG. 13, in some aspects, process 1300 may include receiving, from a second UE, an inter-UE CLI measurement reference signal, the inter-UE CLI measurement reference signal being associated with a CLI configuration, and a channel between the first UE and the second UE being associated with a channel reciprocity (block 1310). For example, the first UE (e.g., using communication manager 140 and/or reception component 1502, depicted in FIG. 15) may receive, from a second UE, an inter-UE CLI measurement reference signal, the inter-UE CLI measurement reference signal being associated with a CLI configuration, and a channel between the first UE and the second UE being associated with a channel reciprocity, as described above.

As further shown in FIG. 13, in some aspects, process 1300 may include transmitting, to a first network node associated with the first UE, a measurement associated with the inter-UE CLI measurement reference signal (block 1320). For example, the first UE (e.g., using communication manager 140 and/or transmission component 1504, depicted in FIG. 15) may transmit, to a first network node associated with the first UE, a measurement associated with the inter-UE CLI measurement reference signal, as described above.

Process 1300 may include additional aspects, such as any single aspect or any combination of aspects described below and/or in connection with one or more other processes described elsewhere herein.

In a first aspect, the first UE is an aggressor UE and the second UE is a victim UE.

In a second aspect, alone or in combination with the first aspect, process 1300 includes determining inter-UE CLI caused to the second UE based at least in part on the measurement associated with the inter-UE CLI measurement reference signal, and process 1300 includes performing an uplink transmit restriction based at least in part on the inter-UE CLI caused to the second UE.

In a third aspect, alone or in combination with one or more of the first and second aspects, process 1300 includes transmitting, to the first network node and based at least in part on the measurement associated with the inter-UE CLI measurement reference signal, a request for a beam change to reduce inter-UE CLI, wherein the request indicates a new candidate beam.

In a fourth aspect, alone or in combination with one or more of the first through third aspects, the CLI configuration is via an OAM node or a CU, and the CLI configuration is associated with a backhaul signaling or an over-the-air signaling.

In a fifth aspect, alone or in combination with one or more of the first through fourth aspects, the inter-UE CLI measurement reference signal indicates a transmitting UE identifier or a transmitting CLI resource identifier to distinguish between different aggressor UEs.

In a sixth aspect, alone or in combination with one or more of the first through fifth aspects, the inter-UE CLI measurement reference signal is code division multiplexed across multiple transmitting UEs.

In a seventh aspect, alone or in combination with one or more of the first through sixth aspects, the CLI configuration indicates inter-UE CLI transmission parameters, and the inter-UE CLI transmission parameters include one or more of a time location, a frequency location, a reference signal sequence identifier, beam information, or a periodicity between different UEs of different cells or different network nodes.

In an eighth aspect, alone or in combination with one or more of the first through seventh aspects, the CLI configuration indicates inter-UE CLI monitoring parameters, and the inter-UE CLI monitoring parameters include a monitoring window location and periodicity between different UEs of different cells or different network nodes.

In a ninth aspect, alone or in combination with one or more of the first through eighth aspects, a signaling of an inter-UE CLI measurement report between the first network node and the second network node is based at least in part on an event trigger, and the event trigger occurs based at least in part on an inter-UE CLI level between the first network node and the second network node satisfying a threshold.

In a tenth aspect, alone or in combination with one or more of the first through ninth aspects, an inter-UE CLI measurement report signaled between the first network node and the second network node includes one or more of an aggressor UE identifier, a CLI resource identifier, upcoming UE data or control scheduling information, a suggested UE power backoff value, beam information, or an indication of time-frequency resources.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a second UE, in accordance with the present disclosure. Example process 1400 is an example where the second UE (e.g., second UE 120e) performs operations associated with transmitting inter-UE CLI reference signals for CLI mitigation.

As shown in FIG. 14, in some aspects, process 1400 may include receiving, from a second network node associated with the second UE, a CLI configuration (block 1410). For example, the second UE (e.g., using reception component 1602, depicted in FIG. 16) may receive, from a second network node associated with the second UE, a CLI configuration, as described above.

As further shown in FIG. 14, in some aspects, process 1400 may include transmitting, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity (block 1420). For example, the second UE (e.g., using transmission component 1604, depicted in FIG. 16) may transmit, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity, as described above.

Process 1400 may include additional aspects, such as any single aspect or any combination of aspects described below and/or in connection with one or more other processes described elsewhere herein.

In a first aspect, the second UE is a victim UE and the first UE is an aggressor UE.

In a second aspect, alone or in combination with the first aspect, the CLI configuration is via an OAM node or a CU, and the CLI configuration is associated with a backhaul signaling or an over-the-air signaling.

In a third aspect, alone or in combination with one or more of the first and second aspects, the inter-UE CLI measurement reference signal indicates a transmitting UE identifier or a transmitting CLI resource identifier to distinguish between different aggressor UEs.

In a fourth aspect, alone or in combination with one or more of the first through third aspects, the inter-UE CLI measurement reference signal is code division multiplexed across multiple transmitting UEs.

In a fifth aspect, alone or in combination with one or more of the first through fourth aspects, the CLI configuration indicates inter-UE CLI transmission parameters, and the inter-UE CLI transmission parameters include one or more of a time location, a frequency location, a reference signal sequence identifier, beam information, or a periodicity between different UEs of different cells or different network nodes.

In a sixth aspect, alone or in combination with one or more of the first through fifth aspects, the CLI configuration indicates inter-UE CLI monitoring parameters, and the inter-UE CLI monitoring parameters include a monitoring window location and periodicity between different UEs of different cells or different network nodes.

In a seventh aspect, alone or in combination with one or more of the first through sixth aspects, a signaling of an inter-UE CLI measurement report between the first network node and the second network node is based at least in part on an event trigger, and the event trigger occurs based at least in part on an inter-UE CLI level between the first network node and the second network node satisfying a threshold.

In an eighth aspect, alone or in combination with one or more of the first through seventh aspects, an inter-UE CLI measurement report signaled between the first network node and the second network node includes one or more of an aggressor UE identifier, a CLI resource identifier, upcoming UE data or control scheduling information, a suggested UE power backoff value, beam information, or an indication of time-frequency resources.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a first UE, or a first UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of a performance component 1508, or a determination component 1510, among other examples.

In some aspects, the apparatus 1500 may be configured to perform one or more operations described herein in connection with FIGS. 9-10. Additionally, or alternatively, the apparatus 1500 may be configured to perform one or more processes described herein, such as process 1100 of FIG. 11, process 1300 of FIG. 13, or a combination thereof. In some aspects, the apparatus 1500 and/or one or more components shown in FIG. 15 may include one or more components of the first UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the first UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the first UE described in connection with FIG. 2. In some aspects, the transmission component 1504 may be co-located with the reception component 1502 in a transceiver.

The reception component 1502 may receive, from a first network node associated with the first UE, a CLI configuration. The transmission component 1504 may transmit, to a second UE, an inter-UE CLI measurement reference signal based at least in part on the CLI configuration, a measurement associated with the inter-UE CLI measurement reference signal being signaled to the first network node.

The reception component 1502 may receive, from the first network node, an indication of an uplink transmission restriction, wherein the uplink transmission restriction is based at least in part on the measurement associated with the inter-UE CLI measurement reference signal. The performance component 1508 may perform the uplink transmission restriction based at least in part on the indication received from the first network node.

The reception component 1502 may receive, from a second UE, an inter-UE CLI measurement reference signal, the inter-UE CLI measurement reference signal being associated with a CLI configuration, and a channel between the first UE and the second UE being associated with a channel reciprocity. The transmission component 1504 may transmit, to a first network node associated with the first UE, a measurement associated with the inter-UE CLI measurement reference signal.

The determination component 1510 may determine inter-UE CLI caused to the second UE based at least in part on the measurement associated with the inter-UE CLI measurement reference signal. The performance component 1508 may perform an uplink transmit restriction based at least in part on the inter-UE CLI caused to the second UE. The transmission component 1504 may transmit, to the first network node and based at least in part on the measurement associated with the inter-UE CLI measurement reference signal, a request for a beam change to reduce inter-UE CLI, wherein the request indicates a new candidate beam.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a second UE, or a second UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 9-10. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the second UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the second UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the second UE described in connection with FIG. 2. In some aspects, the transmission component 1604 may be co-located with the reception component 1602 in a transceiver.

The reception component 1602 may receive, from a first UE, an inter-UE CLI measurement reference signal, the inter-UE CLI measurement reference signal being associated with a CLI configuration. The transmission component 1604 may transmit, to a first network node associated with the first UE via a second network node associated with the second UE, a measurement associated with the inter-UE CLI measurement reference signal. The transmission component 1604 may transmit, to the second network node and based at least in part on the measurement associated with the inter-UE CLI measurement reference signal, a request for a beam change to reduce inter-UE CLI, wherein the request indicates a new candidate beam.

The reception component 1602 may receive, from a second network node associated with the second UE, a CLI configuration. The transmission component 1604 may transmit, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by an apparatus of a first user equipment (UE), comprising: receiving, from a first network node associated with the first UE, a cross-link interference (CLI) configuration; and transmitting, to a second UE, an inter-UE CLI measurement reference signal based at least in part on the CLI configuration, a measurement associated with the inter-UE CLI measurement reference signal being signaled to the first network node.

Aspect 2: The method of Aspect 1, wherein the first UE is an aggressor UE and the second UE is a victim UE.

Aspect 3: The method of any of Aspects 1 through 2, further comprising: receiving, from the first network node, an indication of an uplink transmission restriction, wherein the uplink transmission restriction is based at least in part on the measurement associated with the inter-UE CLI measurement reference signal; and performing the uplink transmission restriction based at least in part on the indication received from the first network node.

Aspect 4: The method of any of Aspects 1 through 3, wherein the CLI configuration is via an operations, administration, and maintenance (OAM) node or a central unit (CU), and wherein the CLI configuration is associated with a backhaul signaling or an over-the-air signaling.

Aspect 5: The method of any of Aspects 1 through 4, wherein the inter-UE CLI measurement reference signal indicates a transmitting UE identifier or a transmitting CLI resource identifier to distinguish between different aggressor UEs.

Aspect 6: The method of any of Aspects 1 through 5, wherein the inter-UE CLI measurement reference signal is code division multiplexed across multiple transmitting UEs.

Aspect 7: The method of any of Aspects 1 through 6, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

Aspect 8: The method of any of Aspects 1 through 7, wherein the CLI configuration indicates inter-UE CLI monitoring parameters, and wherein the inter-UE CLI monitoring parameters include a monitoring window location and periodicity between different UEs of different cells or different network nodes.

Aspect 9: The method of any of Aspects 1 through 8, wherein a signaling of an inter-UE CLI measurement report between the first network node and the second network node is based at least in part on an event trigger, and wherein the event trigger occurs based at least in part on an inter-UE CLI level between the first network node and the second network node satisfying a threshold.

Aspect 10: The method of any of Aspects 1 through 9, wherein an inter-UE CLI measurement report signaled between the first network node and the second network node includes one or more of: an aggressor UE identifier, a CLI resource identifier, upcoming UE data or control scheduling information, a suggested UE power backoff value, beam information, or an indication of time-frequency resources.

Aspect 11: A method of wireless communication performed by an apparatus of a second user equipment (UE), comprising: receiving, from a first UE, an inter-UE cross-link interference (CLI) measurement reference signal, the inter-UE CLI measurement reference signal being associated with a CLI configuration; and transmitting, to a first network node associated with the first UE via a second network node associated with the second UE, a measurement associated with the inter-UE CLI measurement reference signal.

Aspect 12: The method of Aspect 11, wherein the second UE is a victim UE and the first UE is an aggressor UE.

Aspect 13: The method of any of Aspects 11 through 12, further comprising: transmitting, to the second network node and based at least in part on the measurement associated with the inter-UE CLI measurement reference signal, a request for a beam change to reduce inter-UE CLI, wherein the request indicates a new candidate beam.

Aspect 14: The method of any of Aspects 11 through 13, wherein the CLI configuration is via an operations, administration, and maintenance (OAM) node or a central unit (CU), and wherein the CLI configuration is associated with a backhaul signaling or an over-the-air signaling.

Aspect 15: The method of any of Aspects 11 through 14, wherein the inter-UE CLI measurement reference signal indicates a transmitting UE identifier or a transmitting CLI resource identifier to distinguish between different aggressor UEs.

Aspect 16: The method of any of Aspects 11 through 15, wherein the inter-UE CLI measurement reference signal is code division multiplexed across multiple transmitting UEs.

Aspect 17: The method of any of Aspects 11 through 16, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

Aspect 18: The method of any of Aspects 11 through 17, wherein the CLI configuration indicates inter-UE CLI monitoring parameters, and wherein the inter-UE CLI monitoring parameters include a monitoring window location and periodicity between different UEs of different cells or different network nodes.

Aspect 19: The method of any of Aspects 11 through 18, wherein a signaling of an inter-UE CLI measurement report between the first network node and the second network node is based at least in part on an event trigger, and wherein the event trigger occurs based at least in part on an inter-UE CLI level between the first network node and the second network node satisfying a threshold.

Aspect 20: The method of any of Aspects 11 through 19, wherein an inter-UE CLI measurement report signaled between the first network node and the second network node includes one or more of: an aggressor UE identifier, a CLI resource identifier, upcoming UE data or control scheduling information, a suggested UE power backoff value, beam information, or an indication of time-frequency resources.

Aspect 21: A method of wireless communication performed by an apparatus of a first user equipment (UE), comprising: receiving, from a second UE, an inter-UE cross-link interference (CLI) measurement reference signal, the inter-UE CLI measurement reference signal being associated with a CLI configuration, and a channel between the first UE and the second UE being associated with a channel reciprocity; and transmitting, to a first network node associated with the first UE, a measurement associated with the inter-UE CLI measurement reference signal.

Aspect 22: The method of Aspect 21, wherein the first UE is an aggressor UE and the second UE is a victim UE.

Aspect 23: The method of any of Aspects 21 through 22, further comprising: determining inter-UE CLI caused to the second UE based at least in part on the measurement associated with the inter-UE CLI measurement reference signal; and performing an uplink transmit restriction based at least in part on the inter-UE CLI caused to the second UE.

Aspect 24: The method of any of Aspects 21 through 23, further comprising: transmitting, to the first network node and based at least in part on the measurement associated with the inter-UE CLI measurement reference signal, a request for a beam change to reduce inter-UE CLI, wherein the request indicates a new candidate beam.

Aspect 25: The method of any of Aspects 21 through 24, wherein the CLI configuration is via an operations, administration, and maintenance (OAM) node or a central unit (CU), and wherein the CLI configuration is associated with a backhaul signaling or an over-the-air signaling.

Aspect 26: The method of any of Aspects 21 through 25, wherein the inter-UE CLI measurement reference signal indicates a transmitting UE identifier or a transmitting CLI resource identifier to distinguish between different aggressor UEs.

Aspect 27: The method of any of Aspects 21 through 26, wherein the inter-UE CLI measurement reference signal is code division multiplexed across multiple transmitting UEs.

Aspect 28: The method of any of Aspects 21 through 27, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

Aspect 29: The method of any of Aspects 21 through 28, wherein the CLI configuration indicates inter-UE CLI monitoring parameters, and wherein the inter-UE CLI monitoring parameters include a monitoring window location and periodicity between different UEs of different cells or different network nodes.

Aspect 30: The method of any of Aspects 21 through 29, wherein a signaling of an inter-UE CLI measurement report between the first network node and the second network node is based at least in part on an event trigger, and wherein the event trigger occurs based at least in part on an inter-UE CLI level between the first network node and the second network node satisfying a threshold.

Aspect 31: The method of any of Aspects 21 through 30, wherein an inter-UE CLI measurement report signaled between the first network node and the second network node includes one or more of: an aggressor UE identifier, a CLI resource identifier, upcoming UE data or control scheduling information, a suggested UE power backoff value, beam information, or an indication of time-frequency resources.

Aspect 32: A method of wireless communication performed by an apparatus of a second user equipment (UE), comprising: receiving, from a second network node associated with the second UE, a cross-link interference (CLI) configuration; and transmitting, to a first UE, an inter-UE CLI measurement reference signal based at least in part on the CLI configuration, a measurement associated with the inter-UE CLI measurement reference signal being signaled to a first network node associated with the first UE, and a channel between the second UE and the first UE being associated with a channel reciprocity.

Aspect 33: The method of Aspect 32, wherein the second UE is a victim UE and the first UE is an aggressor UE.

Aspect 34: The method of any of Aspects 32 through 33, wherein the CLI configuration is via an operations, administration, and maintenance (OAM) node or a central unit (CU), and wherein the CLI configuration is associated with a backhaul signaling or an over-the-air signaling.

Aspect 35: The method of any of Aspects 32 through 34, wherein the inter-UE CLI measurement reference signal indicates a transmitting UE identifier or a transmitting CLI resource identifier to distinguish between different aggressor UEs.

Aspect 36: The method of any of Aspects 32 through 35, wherein the inter-UE CLI measurement reference signal is code division multiplexed across multiple transmitting UEs.

Aspect 37: The method of any of Aspects 32 through 36, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

Aspect 38: The method of any of Aspects 32 through 37, wherein the CLI configuration indicates inter-UE CLI monitoring parameters, and wherein the inter-UE CLI monitoring parameters include a monitoring window location and periodicity between different UEs of different cells or different network nodes.

Aspect 39: The method of any of Aspects 32 through 38, wherein a signaling of an inter-UE CLI measurement report between the first network node and the second network node is based at least in part on an event trigger, and wherein the event trigger occurs based at least in part on an inter-UE CLI level between the first network node and the second network node satisfying a threshold.

Aspect 40: The method of any of Aspects 32 through 39, wherein an inter-UE CLI measurement report signaled between the first network node and the second network node includes one or more of: an aggressor UE identifier, a CLI resource identifier, upcoming UE data or control scheduling information, a suggested UE power backoff value, beam information, or an indication of time-frequency resources.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
one or more memories; and
one or more processors, coupled to the one or more memories, which are configured, individually or in any combination, to:
receive, from a first network node associated with the first UE, a cross-link interference (CLI) configuration; and
transmit, to a second UE, an inter-UE CLI measurement reference signal based at least in part on the CLI configuration, the inter-UE CLI measurement reference signal being transmitted to the second UE for measurement by the second UE.

2. The apparatus of claim 1, wherein the first UE is an aggressor UE and the second UE is a victim UE.

3. The apparatus of claim 1, wherein the one or more processors are further configured, individually or in any combination, to:
receive, from the first network node, an indication of an uplink transmission restriction, wherein the uplink transmission restriction is based at least in part on the measurement associated with the inter-UE CLI measurement reference signal; and
perform the uplink transmission restriction based at least in part on the indication received from the first network node.

4. The apparatus of claim 1, wherein the CLI configuration is via an operations, administration, and maintenance (OAM) node or a central unit (CU), and wherein the CLI configuration is associated with a backhaul signaling or an over-the-air signaling.

5. The apparatus of claim 1, wherein the inter-UE CLI measurement reference signal indicates a transmitting UE identifier or a transmitting CLI resource identifier to distinguish between different aggressor UEs.

6. The apparatus of claim 1, wherein the inter-UE CLI measurement reference signal is code division multiplexed across multiple transmitting UEs.

7. The apparatus of claim 1, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

8. The apparatus of claim 1, wherein the CLI configuration indicates inter-UE CLI monitoring parameters, and wherein the inter-UE CLI monitoring parameters include a monitoring window location and periodicity between different UEs of different cells or different network nodes.

9. The apparatus of claim 1, wherein a signaling of an inter-UE CLI measurement report between the first network node and a second network node is based at least in part on an event trigger, and wherein the event trigger occurs based at least in part on an inter-UE CLI level between the first network node and the second network node satisfying a threshold.

10. The apparatus of claim 1, wherein an inter-UE CLI measurement report signaled between the first network node and a second network node includes one or more of: an aggressor UE identifier, a CLI resource identifier, upcoming UE data or control scheduling information, a suggested UE power backoff value, beam information, or an indication of time-frequency resources.

11. An apparatus for wireless communication at a second user equipment (UE), comprising:
one or more memories; and
one or more processors, coupled to the one or more memories, which are configured, individually or in any combination, to:
receive, from a first UE, an inter-UE cross-link interference (CLI) measurement reference signal, the inter-UE CLI measurement reference signal being associated with a CLI configuration; and
transmit, to a first network node associated with the first UE via a second network node associated with the second UE, a measurement associated with the inter-UE CLI measurement reference signal.

12. The apparatus of claim 11, wherein the second UE is a victim UE and the first UE is an aggressor UE.

13. The apparatus of claim 11, wherein the one or more processors are further configured, individually or in any combination, to:
transmit, to the second network node and based at least in part on the measurement associated with the inter-UE CLI measurement reference signal, a request for a beam change to reduce inter-UE CLI, wherein the request indicates a new candidate beam.

14. The apparatus of claim 11, wherein the CLI configuration is via an operations, administration, and maintenance (OAM) node or a central unit (CU), and wherein the CLI configuration is associated with a backhaul signaling or an over-the-air signaling.

15. The apparatus of claim 11, wherein the inter-UE CLI measurement reference signal indicates a transmitting UE identifier or a transmitting CLI resource identifier to distinguish between different aggressor UEs.

16. An apparatus for wireless communication at a first user equipment (UE), comprising:
one or more memories; and
one or more processors, coupled to the one or more memories, which are configured, individually or in any combination, to:
receive, from a second UE, an inter-UE cross-link interference (CLI) measurement reference signal, the inter-UE CLI measurement reference signal being associated with a CLI configuration, and a channel between the first UE and the second UE being associated with a channel reciprocity; and
transmit, to a first network node associated with the first UE, a measurement associated with the inter-UE CLI measurement reference signal.

17. The apparatus of claim 16, wherein the first UE is an aggressor UE and the second UE is a victim UE.

18. The apparatus of claim 16, wherein the one or more processors are further configured, individually or in any combination, to:
determine inter-UE CLI caused to the second UE based at least in part on the measurement associated with the inter-UE CLI measurement reference signal; and
perform an uplink transmit restriction based at least in part on the inter-UE CLI caused to the second UE.

19. The apparatus of claim 16, wherein the one or more processors are further configured, individually or in any combination, to:
transmit, to the first network node and based at least in part on the measurement associated with the inter-UE CLI measurement reference signal, a request for a beam change to reduce inter-UE CLI, wherein the request indicates a new candidate beam.

20. The apparatus of claim 16, wherein the CLI configuration is via an operations, administration, and maintenance (OAM) node or a central unit (CU), and wherein the CLI configuration is associated with a backhaul signaling or an over-the-air signaling.

21. The apparatus of claim 16, wherein the inter-UE CLI measurement reference signal indicates a transmitting UE identifier or a transmitting CLI resource identifier to distinguish between different aggressor UEs.

22. The apparatus of claim 16, wherein the inter-UE CLI measurement reference signal is code division multiplexed across multiple transmitting UEs.

23. The apparatus of claim 16, wherein the CLI configuration indicates inter-UE CLI transmission parameters, and wherein the inter-UE CLI transmission parameters include one or more of: a time location, a frequency location, a reference signal sequence identifier, beam information, or a periodicity between different UEs of different cells or different network nodes.

24. The apparatus of claim 16, wherein the CLI configuration indicates inter-UE CLI monitoring parameters, and wherein the inter-UE CLI monitoring parameters include a monitoring window location and periodicity between different UEs of different cells or different network nodes.

25. The apparatus of claim 16, wherein a signaling of an inter-UE CLI measurement report between the first network node and a second network node is based at least in part on an event trigger, and wherein the event trigger occurs based at least in part on an inter-UE CLI level between the first network node and the second network node satisfying a threshold.

26. The apparatus of claim 16, wherein an inter-UE CLI measurement report signaled between the first network node and a second network node includes one or more of: an aggressor UE identifier, a CLI resource identifier, upcoming UE data or control scheduling information, a suggested UE power backoff value, beam information, or an indication of time-frequency resources.

27. An apparatus for wireless communication at a second user equipment (UE), comprising:
one or more memories; and
one or more processors, coupled to the one or more memories, which are configured, individually or in any combination, to:
receive, from a second network node associated with the second UE, a cross-link interference (CLI) configuration; and
transmit, to a first UE, an inter-UE CLI measurement reference signal based at least in part on the CLI configuration, the inter-UE CLI measurement reference signal being transmitted to the first UE for measurement by the first UE, and a channel between the second UE and the first UE being associated with a channel reciprocity.

28. The apparatus of claim 27, wherein the second UE is a victim UE and the first UE is an aggressor UE.

29. The apparatus of claim 27, wherein the CLI configuration is via an operations, administration, and maintenance (OAM) node or a central unit (CU), and wherein the CLI configuration is associated with a backhaul signaling or an over-the-air signaling.

30. The apparatus of claim 27, wherein the inter-UE CLI measurement reference signal indicates a transmitting UE identifier or a transmitting CLI resource identifier to distinguish between different aggressor UEs.
